(19) United States
(12) Patent Application Publication
(10) Pub. No.: US 2005/0248137 A1
(43) Pub. Date: Nov. 10, 2005

(54) Air bag module with vent controlled by tether

(75) Inventors: Neal H. Delventhal, Lake Orion, MI (US); Kurt F. Fischer, Leonard, MI (US); Charles S. Pillsbury IV, Rochester Hills, MI (US); William P. Braun, Romeo, MI (US); John P. Wallner, Rochester Hills, MI (US)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Vehicle Safety Systems Inc.

(21) Appl. No.: 11/181,067

(22) Filed: Jul. 14, 2005

Related U.S. Application Data
(63) Continuation-in-part of application No. 10/878,577, filed on Jun. 28, 2004.
Application No. 10/878,577 is a continuation-in-part of application No. 10/244,933, filed on Sep. 16, 2002.

(51) Int. Cl. B60R 21/28

(52) U.S. Cl. 280/739

(57) ABSTRACT

A vehicle occupant protection apparatus (10d) includes an inflatable vehicle occupant protection device (300), a support member (336) having a vent opening (364), and a vent member (440) that is associated with the vent opening (364). The vent member (440) has a first condition in which the vent member (440) closes the vent opening (364) and a second condition in which the vent member (440) is spaced apart from the vent opening (364) enabling fluid flow through the vent opening (364). A fastener (470) attaches the vent member (440) to the support member (336). The fastener (470) includes structure (482) for securing the vent member (440) in the first condition prior to initial inflation of the protection device (300) and for enabling the vent member (440) to move from the first condition to the second condition upon initial inflation of the protection device (300).

### RELATED APPLICATIONS

This application is a continuation-in-part of copending patent application Ser. No. 10/878,577, filed Jun. 28, 2004, which is a continuation-in-part of patent application Ser. No. 10/244,933, filed Sep. 16, 2002.

### TECHNICAL FIELD

The present invention relates to a vehicle occupant protection apparatus. In particular, the present invention relates to an air bag module having a vent member that is moved between an open condition and a closed condition by a tether of an air bag.

### BACKGROUND OF THE INVENTION

It is known to provide an air bag with a vent. The vent is operative, when the air bag inflates to help protect a vehicle occupant, to discharge inflation fluid from the air bag. In some air bags, the vent may be selectively opened depending on sensed factors, for example, whether the occupant's seat belt is buckled. In other air bags, such as the one shown in U.S. Pat. No. 5,405,166, the vent is formed as two openings that are initially aligned so that the vent is initially open and then closes after the internal bag pressure reaches a predetermined amount. U.S. Pat. No. 5,246,250 shows an air bag that includes a tether attached to a valve flap panel to open or close a vent opening in the air bag when the air bag is inflated and the tether is actuated.

### SUMMARY OF THE INVENTION

The present invention relates to a vehicle occupant protection apparatus comprising an inflatable vehicle occupant protection device, a support member having a vent opening, and a vent member. The vent member is associated with the vent opening and has a first condition in which the vent member closes the vent opening and a second condition in which the vent member is spaced apart from the vent opening enabling fluid flow through the vent opening. The vehicle occupant protection apparatus also comprises a fastener for attaching the vent member to the support member. The fastener includes structure for securing the vent member in the first condition prior to initial inflation of the protection device and for enabling the vent member to move from the first condition to the second condition upon initial inflation of the protection device.

According to another aspect, the present invention relates to a vehicle occupant protection apparatus comprising an inflatable vehicle occupant protection device and an inflator that is actuatable for providing inflation fluid for inflating the protection device. A support member supports the inflator. First and second vent openings extend through the support member on opposite sides of the inflator. The vehicle occupant protection apparatus also comprises a vent member having a first portion associated with the first vent opening and a second portion associated with the second vent opening. The vent member is spaced away from the support member for enabling fluid flow through the first and second vent openings and moves toward the support member for restricting fluid flow through the first and second vent openings. A tether is associated with the vent member and, in response to inflation of the protection device relative to the support member beyond a predetermined amount, moves the vent member toward the support member for restricting fluid flow through the first and second vent openings.

In accordance with yet another aspect, the present invention relates to a vehicle occupant protection apparatus comprising an inflatable vehicle occupant protection device and an inflator that is actuatable for providing inflation fluid for inflating the protection device. A support member supports the inflator. A plurality of vent openings extends through the support member. The vent openings are formed in an array about the inflator. The vehicle occupant protection apparatus also comprises a vent member that is associated with the plurality of vent openings and that extends circumferentially around the inflator. The vent member is spaced away from the support member for enabling fluid flow through the plurality of vent openings and moves toward the support member for restricting fluid flow through the plurality of vent openings. A tether is associated with the vent member and is responsive to inflation of the protection device away from the support member by more than a predetermined amount for moving the vent member toward the support member for restricting fluid flow through the plurality of vent openings.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a sectional view of a portion of a vehicle occupant protection apparatus including an inflatable driver side protection device and a vent in accordance with the present invention, with the vent being open;

FIG. 2 is a view similar to FIG. 1 showing the protection apparatus with the vent closed;

FIG. 3 is a sectional view of a portion of a vehicle occupant protection apparatus and a vent in accordance with a second embodiment of the present invention, with the vent being open;

FIG. 4 is a view similar to FIG. 3 showing the protection apparatus with the vent closed;

FIG. 5 is a sectional view of a portion of a vehicle occupant protection apparatus including an inflatable passenger side protection device and a vent in accordance with a third embodiment of the present invention, with the vent being open;

FIG. 6 is a view similar to FIG. 5 showing the protection apparatus with the vent closed;

FIG. 7 is a sectional view of a vehicle occupant protection apparatus and a vent in accordance with a fourth embodiment of the present invention, with the vent in a first condition;

FIG. 8 is a view similar to FIG. 7 showing the protection apparatus with the vent in a second condition;

FIG. 9 illustrates a vent member for use with the vehicle occupant protection device of FIG. 7;

FIG. 10 illustrates the vehicle occupant protection apparatus of FIG. 7, with the air bag being partially inflated and the vent in the second condition;

FIG. 11 illustrates the vehicle occupant protection apparatus of FIG. 7, with the air bag being near full expansion and the vent being moved from the second condition toward the first condition;

FIG. 12 is a bottom view of a support member of a vehicle occupant protection apparatus and a vent constructed in accordance with a fifth embodiment of the present invention, with the vent in a first condition;

FIG. 13 illustrates a bag retainer connected to an interior surface of the support member of FIG. 12;

FIG. 14 is a view taken along line 14-14 in FIG. 12 and illustrates the vent in the first condition relative to the support member;

FIG. 15 is an enlarged view of a portion of the vehicle occupant protection apparatus of FIG. 14;

FIG. 16 is a view similar to FIG. 14 and illustrating the vent in a second condition relative to the support member; and

FIG. 17 is a view similar to FIG. 16 and illustrating the vent returned to the first condition.

### DETAILED DESCRIPTION OF THE INVENTION

The present invention relates to a vehicle occupant protection apparatus. In particular, the present invention relates to an air bag module having a vent that is moved between an open condition and a closed condition by a tether of an air bag.

As representative of the invention, FIG. 1 illustrates schematically an air bag module 10 that includes an inflatable occupant protection device in the form of an air bag 12. Other vehicle occupant protection devices that can be used in accordance with the invention include, for example, inflatable seat belts, inflatable knee bolsters, inflatable head liners, inflatable side curtains, and knee bolsters operated by inflatable air bags.

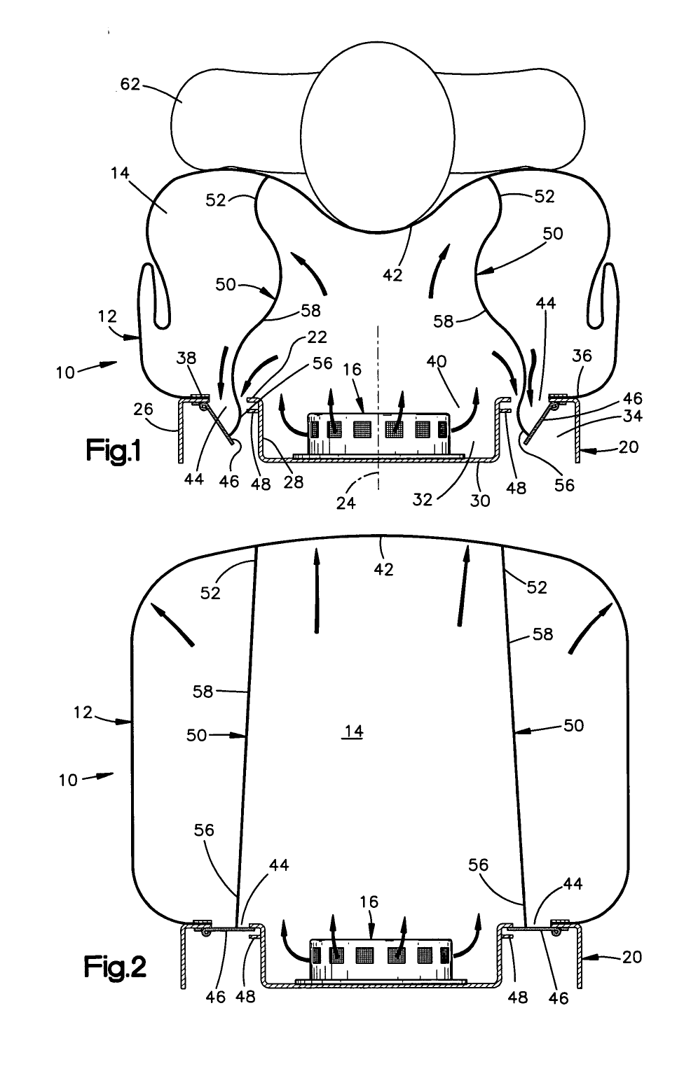

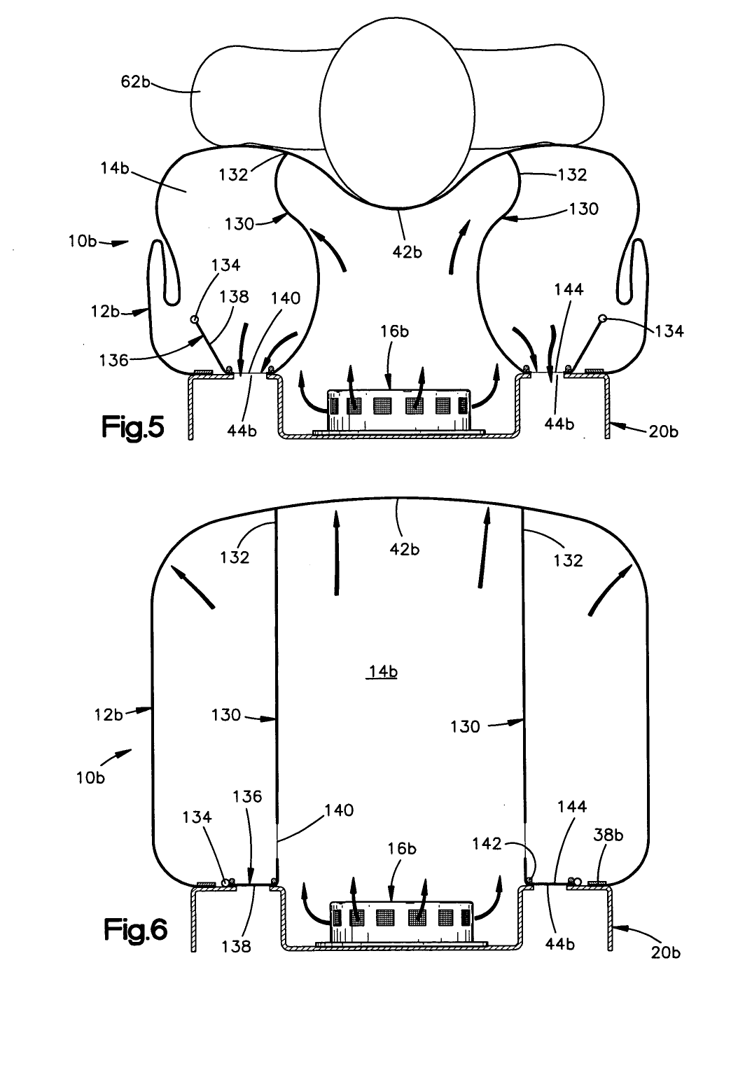

The air bag 12 is preferably made from a flexible fabric material, such as woven nylon, and has an inflation fluid volume 14. The air bag 12 can alternatively be made from a non-woven material, such as plastic film. The air bag 12, when inflated, has a configuration similar to that illustrated in FIG. 2. The air bag 12 of FIGS. 1 and 2 is designed for a driver side application. The invention is applicable to air bags that are used in other locations, for example, passenger side air bags as described below with reference to FIGS. 5 and 6, or side impact air bags.

The module 10 includes an inflator 16 for inflating the air bag 12. The inflator 16 may contain a stored quantity of pressurized inflation fluid and an ignitable material for heating the inflation fluid. The module 10 alternatively could include an inflator 16 that uses the combustion of gas generating material to generate inflation fluid in the form of gas to inflate the air bag 12, or an inflator that contains only a stored quantity of pressurized inflation fluid for inflating the air bag.

The inflator 16 and the air bag 12 are supported on a support member 20. The support member 20 is a member or assembly that is fixed in position on the vehicle, that supports the inflator 16 and the air bag 12, and that receives the reaction forces of the inflator and the air bag when the inflator is actuated. In the illustrated embodiment, the support member 20 is a reaction plate.

The reaction plate 20 is a single piece of material, such as metal or high strength plastic, that is formed to the illustrated configuration. The reaction plate 20 has an annular main body portion 22 centered on an axis 24. A cylindrical rim or outer wall 26 of the reaction plate 20 extends downward (as viewed in FIG. 1) from the main body portion 22. A cylindrical inner wall 28 of the reaction plate 20 extends downward from the main body portion 22 and parallel to the outer wall 26, at a location spaced radially inward from the outer wall 26. A circular center wall 30 caps the inner wall 28.

The inner wall 28 and the center wall 30 of the reaction plate 20 define a cylindrical inflator mounting chamber 32. The inflator 16 is located in the chamber 32 and is secured to the reaction plate 20 in a manner not shown. The inner wall 28 and the outer wall 26 of the reaction plate 20 define a toroidal vent chamber 34, radially outward of the inflator mounting chamber 32.

A mouth portion 36 of the air bag 12 is secured to the main body portion 22 of the reaction plate 20 by a retainer or retainer ring 38. The mouth portion 36 defines an inflation fluid opening 40 for receiving inflation fluid from the inflator 16. The inflation fluid opening 40 allows inflation fluid to flow from the inflator 16 into the inflation fluid volume 14 of the air bag 12 when the inflator is actuated. Opposite the mouth portion 36, the air bag 12 has an outer panel 42 that is located distant from the reaction plate 20 when the air bag is inflated.

Two diametrically opposed vent openings 44 are formed in the main body portion 22 of the reaction plate 20, radially inward of the mouth portion 36 of the air bag 12. The vent openings 44 are identical to each other, each having a circular configuration. It should be understood that more than two vent openings 44 or fewer than two vent openings can be provided, and at locations different than that shown. Also, each vent opening 44 could have a configuration other than a circular configuration, and if plural vent openings are provided, they could have configurations different from each other.

Because the vent openings 44 are located in the main body portion 22 of the reaction plate 20 radially inward of the mouth portion 36 of the air bag 12, the vent openings are in fluid communication with the inflation fluid volume 14 of the air bag. As a result, at least some of the inflation fluid flowing from the inflator 16, when the inflator is actuated, flows across or into the vent openings 44 in the reaction plate 20.

The module includes two vent members 46 for selectively closing the vent openings 44. Each one of the vent members 46 is associated with a respective one of the vent openings 44. The two vent members 46 are identical in the illustrated embodiment.

Each vent member 46 is configured as a circular door that is supported on the reaction plate 20 for pivotal movement relative to the reaction plate. The door 46 is pivotally mounted to the reaction plate at a location adjacent the mouth portion 36 of the air bag 12. The module 10 includes a latch shown schematically at 48 on the inner wall 28 of the reaction plate 20, adjacent each vent opening 44. The latch 48 may be a spring loaded latch member or a bendable tab on the reaction plate 20, for example.

The door 46 has a first condition shown in FIG. 1 in which the door is spaced apart from the vent opening 44 in the reaction plate 20. When the door 46 is in the first condition, the door is pivoted away from the vent opening 44 and away from the inflation fluid volume 14 of the air bag 12 (downward as viewed in FIG. 1), into the vent chamber 34 in the reaction plate 20. When the door 46 is in the first condition, the vent opening 44 is not blocked, and inflation fluid can flow away from the air bag 12 through the vent opening.

The door 46 has a second condition shown in FIG. 2 in which the door is pivoted upward and overlies the vent opening 44 in the reaction plate. The latch 48 holds the door 46 in the second or closed condition. When the door 46 is in the second condition, the vent opening 44 is blocked and inflation fluid cannot flow away from the air bag 12 through the vent opening.

The module 10 includes one or more tethers 50 for controlling or limiting deployment of the air bag 12. In the illustrated embodiment, two identical tethers 50 are provided. Tethers 50 in accordance with the present invention may take any one of many different forms. In the illustrated embodiment, each tether 50 is a narrow, elongate piece or strip of fabric material having a width of from about one-half inch to about two inches. The tether 50 may be made from the same material as the air bag 12, or may be made from a different material. The tether 50 is not, per se, part of the air bag 12, in the sense that the air bag can deploy and inflate whether the tether is present or not.

The tether 50 has a first end portion 52 that is fixed to the outer panel 42 of the air bag 12 by sewing. The first end portion 52 of the tether 50 is thus connected for movement with the air bag 12 as the air bag is deployed.

An opposite second end portion 56 of the tether 50 is connected with or fixed to a vent door 46 for transferring tensile force from the air bag 12 and the tether 50 to the vent door. The second end portion 56 of the tether 50 may be formed as a loop that extends through or around a portion of the door 46 to couple the door for movement with the second end portion of the tether. The second end portion 56 of the tether 50 may be secured to the vent door 46 in another manner, for example, by adhesive. An intermediate portion 58 of the tether 50 extends between and interconnects the first and second end portions 52 and 56.

When the air bag 12 is in a deflated condition (not shown), the outer panel 42 of the air bag is close to or adjacent the mouth portion 36. There is a significant amount of slack in the tether 50. The slack is present because the length of the tether 50 is greater than the distance between the portion of the air bag 12 where the first end portion 52 of the tether is fixed to the outer panel 42 and the portion of the air bag 12 adjacent the second end portion 56 of the tether. In the illustrated embodiment, the slack is provided by the intermediate portion 58 of the tether 50. Because the slack is present, the vent doors 46 are not pulled closed against the reaction plate 20 when the air bag 12 is in the deflated condition, and inflation fluid may be able to flow away from the air bag through the vent openings 44.

If the air bag 12 is to be inflated, an actuation signal is transmitted to the inflator 16. When the inflator 16 is actuated, it emits a large volume of inflation fluid through the mouth portion 36 of the air bag 12 and into the inflation fluid volume 14 of the air bag. The air bag 12 inflates, as shown in FIGS. 1 and 2.

As the air bag 12 inflates, the outer panel 42 of the air bag moves away from the reaction plate 20 and the vent doors 46. If the air bag 12 inflates by less than a certain amount (FIG. 1), the outer panel 42 moves away from the reaction plate 20 by less than a predetermined amount. This might happen, for example, if the air bag 12 when inflating contacts a vehicle occupant (as shown schematically at 62 in FIG. 1) positioned relatively close to the reaction plate 20.

The engagement of the air bag 12 with the relatively close vehicle occupant 62 stops or limits outward movement of the outer panel 42 of the air bag. When this occurs, the tethers 50 are not stretched out sufficiently to remove the slack from the tethers. The tethers 50 do not pull on the vent doors 46, and the vent doors remain in the first condition, spaced apart from the vent openings 44. The vent openings 44 remain open, enabling flow of inflation fluid away from the air bag 12 through the vent openings. This venting of the air bag 12 can reduce the force and pressure with which the air bag inflates.

If the air bag 12 inflates by more than a certain amount (FIG. 2), the outer panel 42 moves away from the reaction plate 20 by a predetermined amount. Such movement might occur if the air bag 12 inflates fully to help protect a vehicle occupant seated against the vehicle seat back. This movement of the outer panel 42 away from the reaction plate 20 by the predetermined amount causes the tethers 50 to be tensioned, as shown in FIG. 2. The distance between the first end portions 52 of the tethers 50 and the second end portions 56 of the tethers increases. The slack is pulled out of the tethers 50 and the tethers pull the vent doors 46 into the second condition or closed condition shown in FIG. 2. The vent openings 44 are closed, blocking flow of inflation fluid away from the air bag 12 through the vent openings. The latches 48 hold the vent doors 46 closed. The air bag 12 inflates with full force and pressure.

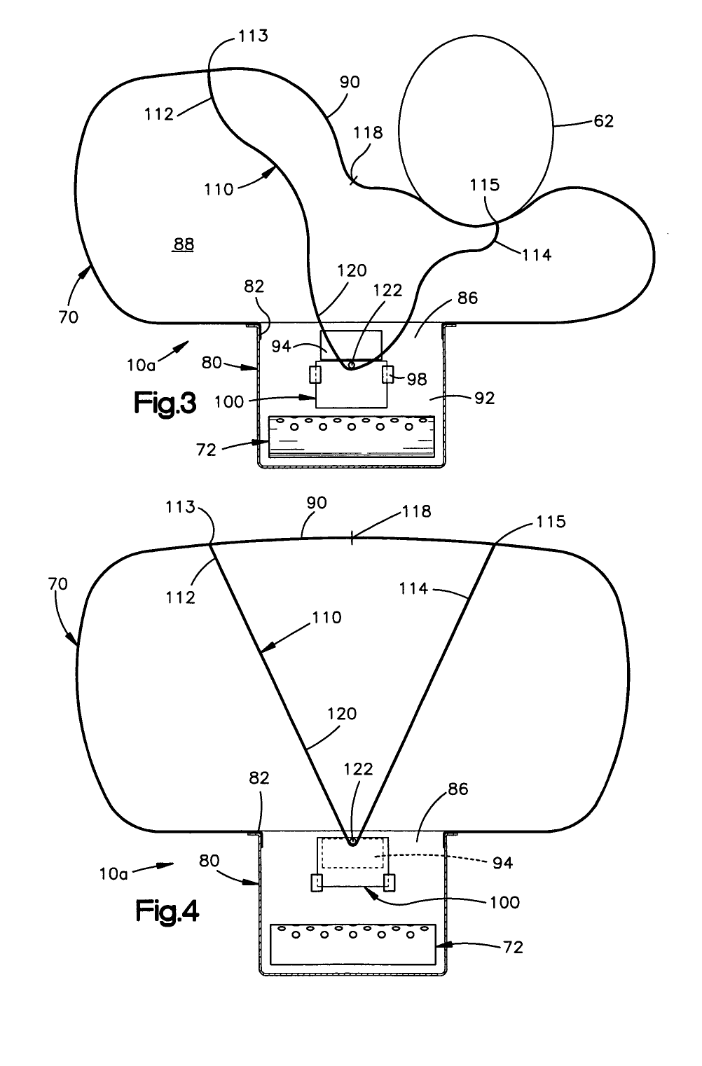

FIGS. 3 and 4 illustrate an air bag module 10a in accordance with a second embodiment of the invention. The air bag module 10a is a passenger side frontal air bag module that includes an air bag 70 and an inflator 72 for inflating the air bag. The air bag 70 and the inflator 72 are mounted on a support member 80. In the illustrated embodiment, the support member 80 is a reaction canister mounted in a vehicle instrument panel. The reaction canister 80 could alternatively be part of the instrument panel itself.

A mouth portion 82 of the air bag 70 is secured to the reaction canister 80. The mouth portion 82 defines an inflation fluid opening 86 for receiving inflation fluid from the inflator 72. The inflation fluid opening 86 allows inflation fluid to flow from the inflator 72 into an inflation fluid volume 88 of the air bag 70 when the inflator 72 is actuated. Opposite the mouth portion 82, the air bag 70 has an outer panel 90 that is located distant from the reaction canister 80 when the air bag is inflated.

The reaction canister 80 as shown has a wall 92 that defines a vent opening 94. The vent opening 94 is in fluid communication with the inflation fluid volume 88 of the air bag 70. A door retainer 98 is fixed to the reaction canister 80 adjacent the vent opening 94.

The module 10a includes a vent member 100 for selectively closing the vent opening 94. The vent member 100 is formed as a door supported on the reaction canister 80 at a location adjacent the vent opening 94. The door 100 is supported on the reaction canister 80 for sliding movement relative to the reaction canister. The door retainer 98 and the wall 92 of the reaction canister 80 cooperate to guide the sliding movement of the door 100.

The door 100 has a first condition shown in FIG. 3 in which the door is spaced apart from the vent opening 94 in the reaction canister 80. When the door 100 is in the first condition, the vent opening 94 in the reaction canister 80 is not blocked, and inflation fluid can flow away from the air bag 70 through the vent opening.

The door 100 has a second condition shown in FIG. 4 in which the door overlies the vent opening 94 in the reaction canister 80. When the door 100 is in the second condition, the vent opening 94 is blocked and inflation fluid cannot flow away from the air bag 70 through the vent opening.

The apparatus 10a includes one or more tethers 110 for controlling operation of the vent door 100. In the illustrated embodiment, only one tether 110 is used. The tether 110 has a first part or first end portion 112 that is fixed to a first portion 113 of the outer panel 90 of the air bag 70. An opposite second part or second end portion 114 of the tether 110 is fixed to a second portion 115 of the outer panel 90. Both the first and second portions 113 and 115 of the air bag 70 are offset laterally from the center point 118 of the outer panel 90.

An intermediate portion 120 of the tether 110 extends around a pin 122 or other portion of the vent door 100. The tether 110 may also extend through a tether guide (not shown) fixed to the reaction canister 80. The intermediate portion 120 of the tether 110 is freely slidable relative to the vent door 100 in response to forces applied to one or both end portions 112 and 114 of the tether. As the intermediate portion 120 of the tether 110 moves relative to the vent door 100, the distance between the first end portion 112 of the tether and the vent door varies in inverse relationship to the distance between the second end portion 114 of the tether and the vent door.

When the air bag 70 is in a deflated condition (not shown), the outer panel 90 of the air bag is close to or adjacent the mouth portion 82. There is a significant amount of slack in the tether 110. The vent door 100 is in the first condition as shown in FIG. 3, in which the vent door does not cover the vent opening 94 in the reaction canister. As a result, inflation fluid may be able to flow away from the air bag 70 through the vent opening 94.

When the air bag 70 is inflated, the outer panel 90 of the air bag moves away from the reaction canister 80 and the vent door 100. The first and second end portions 112 and 114 of the tether 110 also move away from the vent door 100.

The air bag 70 might inflate fully without contacting a vehicle occupant or other object during inflation. In that situation, as shown in FIG. 4, the entire outer panel 90 moves fully away from the vent door 100, carrying with it both the first end portion 112 and the second end portion 114 of the tether 110. Each of the first and second end portions 112 and 114 of the tether 110 moves away from the vent door 100 by a substantial distance. As a result of this movement, the combined distances between (a) the first end portion 112 of the tether 110 and the vent door 100 and (b) the second end portion 114 of the tether and the vent door 100 substantially equal the length of the tether 110 between the first and second end portions. The tether 110 is, therefore, stretched out sufficiently to remove its slack.

The tightened tether 110, through the intermediate portion 120 of the tether, pulls on the pin 122. The vent door 100 is pulled from the first condition to the second condition in which it covers the vent opening 94 in the reaction canister 80. The vent opening 94 in the reaction canister 80 closes, blocking flow of inflation fluid away from the air bag 70 through the vent opening. The air bag 70 inflates with full force and pressure.

The inflating air bag 70 might, alternatively, contact a vehicle occupant positioned relatively close to the reaction canister 80 and centered laterally relative to the reaction canister. If this occurs, the engagement of the air bag 70 with the vehicle occupant stops or limits outward movement of the outer panel 90 of the air bag. If the combined distances between (a) the first end portion 112 of the tether 110 and the vent door 100 and (b) the second end portion 114 of the tether and the vent door substantially equal the length of the tether between the first and second end portions, as described above, then the tether is stretched out sufficiently to remove its slack. The vent door 100 is moved from the open condition to the closed condition, blocking flow of inflation fluid away from the air bag 70 through the vent opening 94.

In another alternative deployment scenario, the combined distances between (a) the first end portion 112 of the tether 110 and the vent door 100 and (b) the second end portion 114 of the tether and the vent door might not substantially equal the length of the tether between the first and second end portions. In this case, the tether 110 is not stretched out sufficiently to remove its slack. The tether 110 does not exert sufficient force on the vent door 100 to move the vent door from the first condition to the second condition.

An example of this deployment scenario is shown in FIG. 3. Even though a portion of the outer panel 90 has moved fully away from the vent door 100, carrying with it the first end portion 112 of the tether 110, the second end portion 114 of the tether remains relatively close to the vent door because of contact with a vehicle occupant 62. Because the intermediate portion 120 of the tether 110 is slidable about the pin 122 of the vent door 100, the movement of the first end portion 112 of the tether away from the vent door causes the distance between the first end portion 112 and the vent door to increase and the distance between the second end portion 114 and the vent door to decrease. The distance between the first end portion 112 of the tether 100 and the vent door 100 varies in inverse relationship to the distance between the second end portion 114 of the tether and the vent door. The movement of the tether 110 therefore does not cause the tether to be tensioned sufficiently to move the vent door. The vent opening 94 remains uncovered, enabling venting of inflation fluid away from the air bag 70.

The tether 110 is thus operative to cause the vent door 100 to move so as to close the vent opening 94 only in response to movement of the first and second tether end portions 112 and 114 away from the vent door by a combined amount in excess of a predetermined amount. That is, the vent door 100 is closed only when the air bag 70 is deployed in a manner such that the combined distances between (a) the first part 112 of the tether 100 and the vent door and between (b) the second part 114 of the tether and the vent door substantially equal the length of the tether between the first and second parts 112 and 114.

FIGS. 5 and 6 illustrate an air bag module 10b in accordance with a third embodiment of the invention. Portions of the air bag module 10b that are the same as or similar to corresponding portions of the air bag module 10 (FIGS. 1-2) are given the same reference numerals with the suffix “b” added.

The module 10b includes an air bag 12b and two identical tethers 130. Each tether 130 has a first end portion 132 that is fixed to the outer panel 42b of the air bag 12b by sewing. An opposite second end portion 134 of each tether 130 is formed as a stop member. Adjacent each stop member 134 is a vent member 136. The vent member 136 includes a solid tether portion 138 and a vent opening 140.

The vent member 136 may be formed as one piece with the tether 130, as shown in FIGS. 5 and 6, including the first end portion 132 and the stop member 134. Alternatively, the vent member 136 may be formed as a separate member attached to the tether 130.

The module 10b includes a tether retainer 142 fixed to the reaction plate 20b, overlying the vent opening 44b in the reaction plate. The tether retainer 142 includes a third vent opening 144 that is aligned with the vent opening 44b in the reaction plate 20b. The vent member 136 is slidable through the tether retainer 142, relative to the reaction plate 20b.

When the air bag 12b is in a deflated condition (not shown), the outer panel 42b of the air bag is close to or adjacent the reaction plate 20b. There is a significant amount of slack in the tethers 130. The vent openings 140 in the vent members 136 are aligned with the vent openings 44b in the reaction plate 20b. As a result, inflation fluid may be able to flow away from the air bag 12b through the vent openings 44b.

When the air bag 12b is inflated, the outer panel 42b of the air bag moves away from the reaction plate 20b and the vent openings 44b. If the air bag 12b inflates by less than a certain amount (FIG. 5), the outer panel 42b moves away from the reaction plate 20b by less than a predetermined amount. This might happen, for example, if the air bag 12b when inflating contacts a vehicle occupant (as shown schematically at 62b in FIG. 5) positioned relatively close to the reaction plate 20b.

The engagement of the air bag 12b with the vehicle occupant 62b stops or limits outward movement of the outer panel 42b of the air bag. The tethers 130 are not stretched out sufficiently to remove the slack from the tethers. The tethers 130 do not pull the vent members 136 through the tether retainer 142, and the vent members 136 remain in the first condition. The vent openings 140 in the vent members 136 are aligned with the vent openings 44b in the reaction plate 20b, enabling flow of inflation fluid away from the air bag 12b through the vent openings. This venting of the air bag 12b can reduce the force and pressure with which the air bag inflates.

If the air bag 12b inflates by more than a certain amount (FIG. 6), the outer panel 42b moves away from the reaction plate 20b by a predetermined amount. Such movement might occur if the air bag inflates fully to help protect a vehicle occupant seated against the vehicle seat back. This movement of the outer panel 42b away from the reaction plate 20b by the predetermined amount causes the tethers 130 to be tensioned, as shown in FIG. 6. The slack is pulled out of the tethers 130. The vent members 136 are pulled through the tether retainer 142 to a second condition in which the solid tether portions 138 of the vent members 136 overlie the vent openings 44b in the reaction plate 20b. The vent openings 44b are closed, blocking flow of inflation fluid away from the air bag 12b through the vent openings. The air bag 12b inflates with full force and pressure.

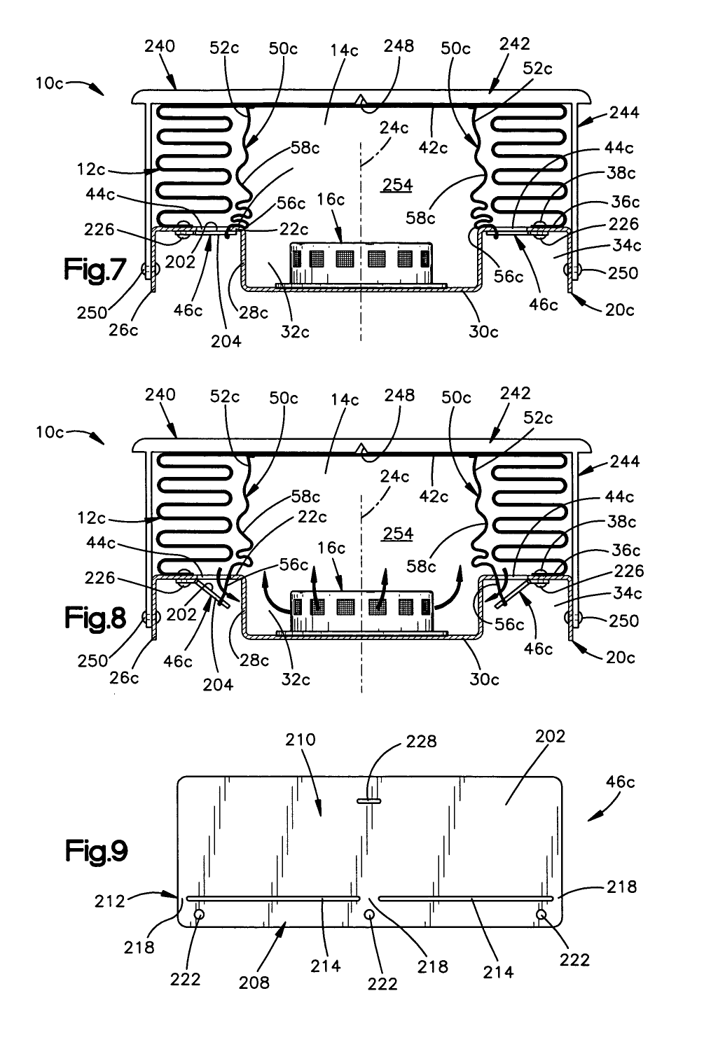

FIG. 7 illustrates an air bag module 10c in accordance with a fourth embodiment of the invention. Portions of the air bag module 10c that are the same as or similar to corresponding portions of the air bag module 10 of FIGS. 1 and 2 are given the same reference numerals with the suffix “c” added.

The air bag module 10c illustrated in FIG. 7 is a driver side frontal air bag module that includes an air bag 12c and an inflator 16c for inflating the air bag. The air bag 12c has an inflation fluid volume 14c. The inflator 16c is actuatable for providing inflation fluid for inflating the air bag 12c.

The inflator 16c and the air bag 12c are supported on a support member 20c. The support member 20c is a member or assembly that is secured to the vehicle and that receives the reaction forces of the inflator 16c and the air bag 12c when the inflator is actuated. In the illustrated embodiment, the support member 20c is a reaction plate.

The reaction plate 20c is a single piece of material, such as metal or high strength plastic, that is formed to the illustrated configuration. The reaction plate 20c has an annular main body portion 22c centered on an axis 24c. An outer wall 26c of the reaction plate 20c extends downward, as viewed in FIG. 7, from the main body portion 22c. A cylindrical inner wall 28c of the reaction plate 20c extends downward, again as viewed in FIG. 7, from the main body portion 22c in a direction parallel to the outer wall 26c at a location spaced radially inwardly from the outer wall. A circular center wall 30c caps the inner wall 28c of the reaction plate 20c.

The inner wall 28c and the center wall 30c of the reaction plate 20c define a cylindrical inflator mounting chamber 32c. The inflator 16c is located in the chamber 32c and is secured to the reaction plate 20c in a known manner. The inner wall 28c and the outer wall 26c of the reaction plate 20c define a toroidal vent chamber 34c of the reaction plate. The toroidal vent chamber 34c is located radially outwardly of the inflator mounting chamber 32c.

A bag retainer 38c secures a mouth portion 36c of the air bag 12c to the main body portion 22c of the reaction plate 20c. The mouth portion 36c of the air bag 12c defines an inflation fluid opening for receiving inflation fluid from the inflator 16c. The inflation fluid opening allows inflation fluid to flow from the inflator 16c into the inflation fluid volume 14c of the air bag 12c when the inflator is actuated. Opposite the mouth portion 36c, the air bag 12c has an outer panel 42c. The outer panel 42c moves away from the reaction plate 20c as the air bag is inflated.

Two diametrically opposed vent openings 44c are formed in the main body portion 22c of the reaction plate 20c. The vent openings 44c are located radially inwardly of the mouth portion 36c of the air bag 12c. The vent openings 44c in the air bag module 10c illustrated in FIG. 7 are identical. A number of vent openings 44c other than two may be provided. The vent openings, when multiple vent openings are provided, may have different configurations from one other. Each of the vent openings 44c of FIG. 7 has a generally rectangular configuration.

The air bag module 10c also includes two vent members 46c. Each one of the vent members 46c is associated with a respective one of the vent openings 44c. The two vent members 46c illustrated in FIG. 7 are identical to one another.

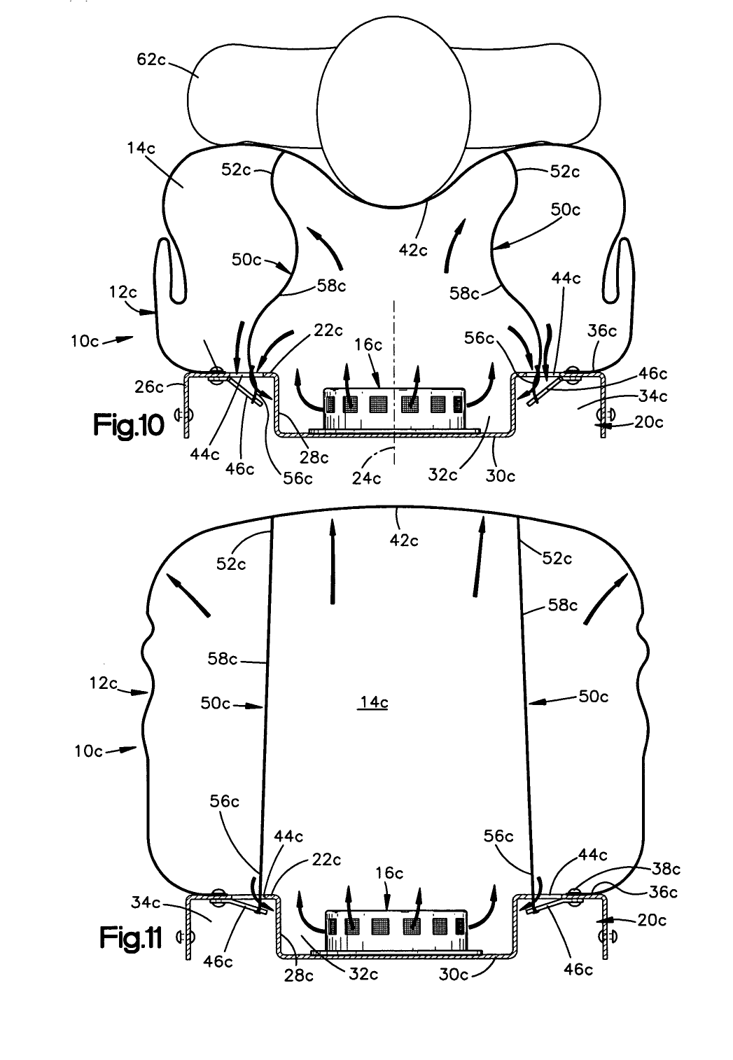

FIG. 9 is a plan view of one of the vent members 46c of the air bag module of FIG. 7. The vent member 46c shown in FIG. 9 is generally planar and has a generally rectangular configuration. The vent member 46c includes opposite upper and lower surfaces 202 and 204, respectively. FIG. 9 only illustrates the upper surface 202 of the vent member 46c. FIGS. 7 and 8 illustrate both the upper and the lower surfaces 202 and 204 of one of the vent members 46c.

As shown in FIG. 9, the vent member 46c includes an attaching portion 208 and a closing portion 210. A living hinge 212 separates the attaching portion 208 and the closing portion 210. The living hinge 212 is formed by two collinear, elongated slots 214 that extend through the vent member 46c and define three hinge portions 218. The living hinge 212 enables bending of the closing portion 210 of the vent member 46c relative to the attaching portion 208.

The attaching portion 208 of the vent member 46c includes three apertures 222. Each aperture 222 is adapted for receiving an associated fastener for fixing the attaching portion 208 of the vent member 46c to the main body portion 22c of the reaction plate 20c. FIGS. 7 and 8 illustrate a portion of a rivet 226 that secures the attaching portion 208 of the vent member 46c to the main body portion 22c of the reaction plate 20c. Fasteners other than rivets may also be used for securing the attaching portion 208 of the vent member 46c to the main body portion 22c of the reaction plate 20c. As an alternative to fasteners, the attaching portion 208 of the vent member 46c may be welded to the main body portion 22c of the reaction plate 20c.

The closing portion 210 of the vent member 46c has dimensions that are greater than the dimension of its associated vent opening 44c. A slot 228 extends through the closing portion 210 of the vent member 46c in a location spaced apart from the living hinge 212.

The vent member 46c is preferably stamped from a single sheet of steel. The vent member 46c has a material stiffness sufficient to prevent bending or warping of the vent member due to vibrations or temperature extremes that are common in vehicles.

As shown in FIGS. 7 and 8, when the vent member 46c is attached to the main body portion 22c of the reaction plate 20c, the vent member 46c is located in the toroidal vent chamber 34c of the reaction plate 20c. The attaching portion 208 of the vent member 46c is secured to the reaction plate 20c in a location for positioning the closing portion 210 across its associated vent opening 44c. Thus, when the vent member 46c is positioned as shown in FIG. 7, the closing portion 210 closes its associated vent opening 44c. When the closing portion 210 of the vent member 46c closes its associated vent opening 44c, as is shown in FIG. 7, the vent member is said to be in a first condition.

The vent member 46c also has a second condition. FIG. 8 illustrates the vent member in the second condition. In the second condition, the vent member 46c is bent at the living hinge 212 so that the closing portion 210 of the vent member 46c is spaced apart from its associated vent opening 44c in the reaction plate 20c. When the vent member 46c is in the second condition, its associated vent opening 44c is open so that fluid may flow through the vent opening.

The air bag module 10c also includes two tethers 50c. Each of the tethers 50c is associated with a different one of the vent members 46c. Each tether 50c has a first end portion 52c that is fixed to the outer panel 42c of the air bag 12c by sewing. The first end portion 52c of the tether 50c is thus connected for movement with the outer panel 42c of the air bag 12c as the air bag is inflated. An opposite second end portion 56c of each tether 50c is attached to the associated vent member 46c. To connect the second end portion 56c to its associated vent member 46c, the second end portion 56c is inserted through the slot 228 in the closing portion 210 of the vent member 46c from the upper surface 202 to the lower surface 204 and is knotted at a location below the lower surface. As an alternative to being knotted, the second end portion 56c of the tether 50c may be connected with an element, such as a washer (not shown), having dimensions greater than the dimensions of the slot 228. When the second end portion 56c of the tether 50c extends through the slot 228, fluid flow through the slot 228 is essentially prevented. Other methods of connecting the second end portion 56c to the closing portion 210 of the vent member 46c are also contemplated by this invention. For example, a fastener (not shown) may connect the second end portion 56c of the tether 50c to the closing portion 210 of the vent member 46c.

The air bag module 10c also includes a cover 240. The cover 240 includes a front panel 242 and an annular side panel 244. The front panel 242 of the cover 240 includes a tear seam 248 that ruptures to enable deployment of the air bag 12c from the air bag module 10c. The side panel 244 of the cover 240 extends perpendicularly from the front panel 242. A lower portion of the side panel 244 is located radially outwardly of the outer wall 26c of the reaction plate 20c. A plurality of fasteners 250, two of which are shown in FIG. 7, attached the side panel 244 of the cover 240 to the outer wall 26c of the reaction plate 20c.

A chamber 254 is defined in the air bag module 10c between the cover 240 and the reaction plate 20c. When the air bag module 10c is in a non-actuated condition, as shown in FIG. 7, the deflated air bag 12c is folded and stored in the chamber 254. When stored in the chamber 254, the outer panel 42c of the air bag 12c is adjacent the front panel 242 of the cover 240. Also when the air bag module 10c is in the non-actuated condition, there is a significant amount of slack in the tethers 50c. The slack is present because the length of each tether 50c is greater than the distance between the portion of the air bag 12c where the first end portion 52c of the tether is fixed to the outer panel 42c and the vent member 46c where the second end portion 56c of the tether is located. The slack is provided by intermediate portions 58c of the tethers 50.

When the air bag module 10c is in the non-actuated condition, as is shown in FIG. 7, the vent members 46c are in the first condition closing their associated vent openings 44c. When the vent members 46c are in the first condition, debris and other foreign matter are prevented from entering the chamber 254 of the air bag module 10c through the vent openings 44c. The vent members 46c of the air bag module 10c are in the first condition prior to actuation of the inflator 16c.

When the inflator 16c of the air bag module 10c is actuated, inflation fluid exits the inflator 16c and begins to fill the air bag 12c. In response to receiving inflation fluid from the inflator 16c, the air bag 12c expands slightly within the chamber 254 and begins to press against the front panel 242 of the cover 240. As additional inflation fluid enter the air bag 12c, the inflation fluid pressure within the air bag 12c increases. The inflation fluid pressure within the air bag 12c acts on the upper surfaces 202 of the vent members 46c. Since the lower surfaces 204 of the vent members 46c are subject to atmospheric pressure, a pressure differential arises across the closing portion 210 of each vent member 46c. When the pressure differential reaches a predetermined level, each vent member 46c bends at its living hinge 212 and the closing portion 210 moves away from the vent opening 44c. Thus, in response to the pressure differential, the vent members 46c move from the first condition, shown in FIG. 7, to the second condition, shown in FIG. 8. When the vent members 46c are in the second condition, inflation fluid may flow out of the chamber 254 through the vent openings 44c.

At the point of air bag deployment illustrated in FIG. 8, the output of inflation fluid from the inflator 16c is greater than the amount of inflation fluid that may exit the air bag 12c through the vent openings 44c. As a result, the inflation fluid pressure within the air bag 12c continues to increase after the vent members 46c are moved to the second condition. The increasing inflation fluid pressure in the air bag 12c results in an increasing pressure applied to the front panel 242 of the cover 240. The increasing pressure applied to the front panel 242 of the cover 240 eventually ruptures the tear seam 248 of the front panel of the cover and enables the air bag 12c to expand outward of the chamber 254 of the air bag module 10c.

FIGS. 10 and 11 illustrate the air bag 12c expanded outward of the chamber 254 of the air bag module 10c. FIG. 10 illustrates the air bag 12c partially expanded with the outer panel 42c having moved away from the reaction plate 20c by less than the predetermined amount. FIG. 11 illustrates the air bag 12c near full expansion with the outer panel 42c having moved away from the reaction plate 20c by more than the predetermined amount. For ease of illustration, the cover 240 is not shown in FIGS. 10 and 11.

As the air bag 12c inflates, the outer panel 42c of the air bag 12c moves away from the reaction plate 20c and away from the vent members 46c. If the outer panel 42c moves away from the reaction plate 20c by less than the predetermined amount, slack remains in the tethers 50c. The outer panel 42c of the air bag 12c may move away from the reaction plate 20c by less than the predetermined amount, for example, if the air bag 12c when inflating engages a vehicle occupant (as shown schematically at 62c in FIG. 10) who is positioned relatively close to the reaction plate 20c. The engagement of the air bag 12c with the relatively close vehicle occupant 62c stops or limits the movement of the outer panel 42c of the air bag away from the reaction plate 20c and away from the vent members 46c.

When slack remains in the tethers 50c as a result of the outer panel 42c moving away from the reaction plate 20c by less than the predetermined amount, the tethers 50 do not pull on the vent members 46c. The vent members 46c remain in the second condition spaced apart from the vent openings 44c. The vent openings 44c remain open, enabling the flow of inflation fluid away from the air bag 12c through the vent openings and to atmosphere. This venting of the air bag 12c can reduce the force and pressure with which the air bag inflates.

When the outer panel 42c of the air bag 12c moves away from the reaction plate 20c by more than the predetermined amount, as is shown in FIG. 11, the slack is completely removed from the tethers 50c and the tethers are tensioned. The tensioned tethers 50c pull the vent members 46c from the second condition, shown in FIG. 10, back toward the first condition in which the vent members 16c block the flow of inflation through the vent openings 44c. When the vent members 46c are moved back into the first condition during inflation of the air bag 12c, the air bag 12c inflates with full force and pressure.

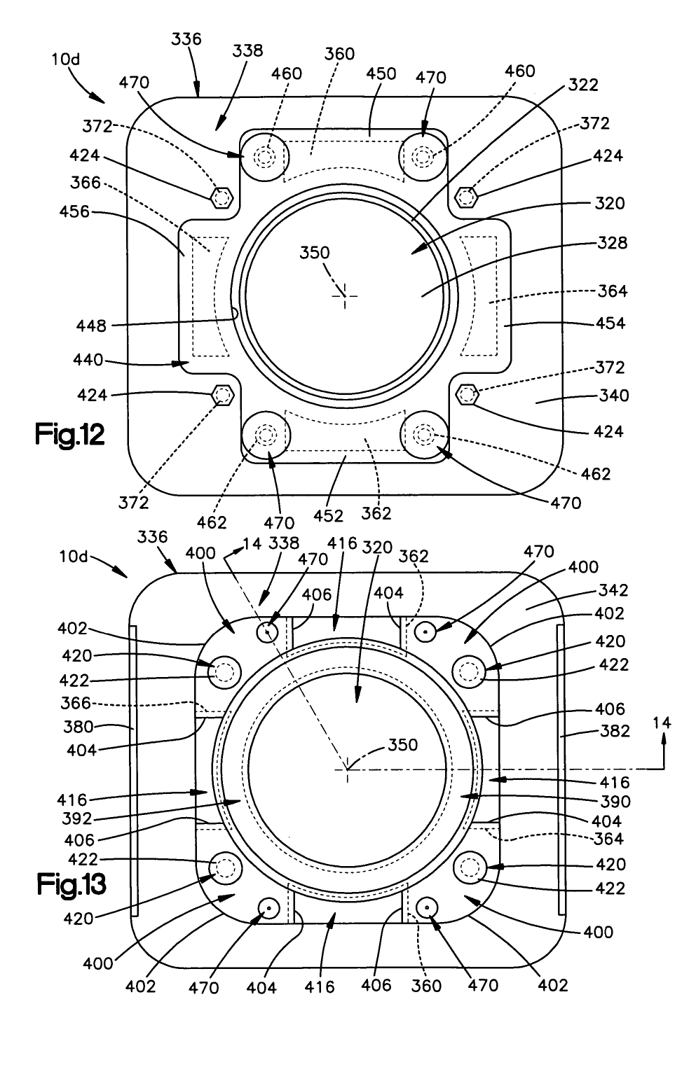

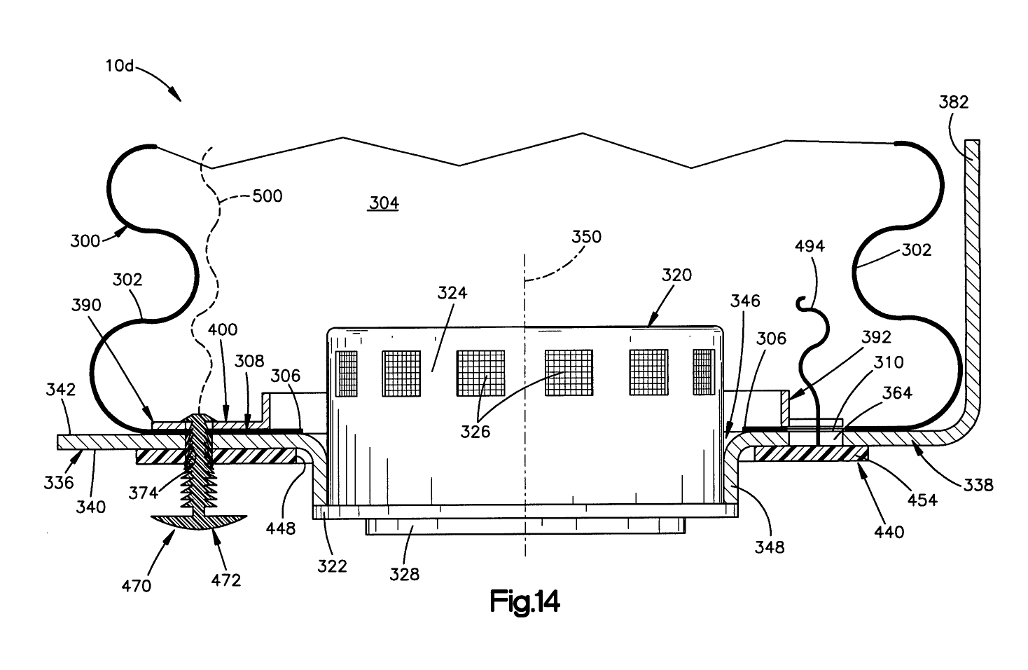

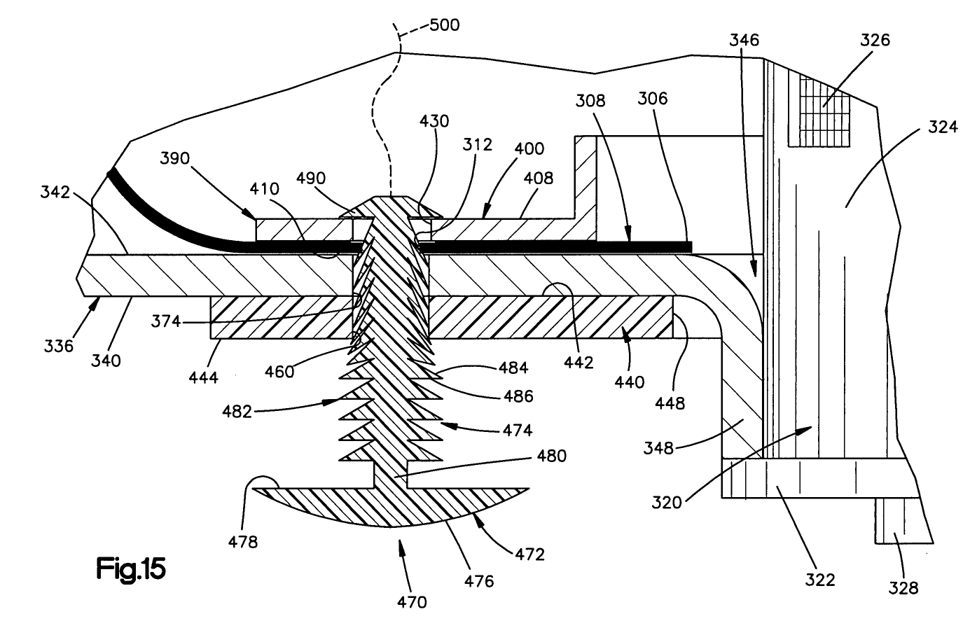

A fifth embodiment of the present invention is illustrated with reference to FIGS. 12-17. With reference to FIG. 14, the air bag module 10d of the fifth embodiment includes an air bag 300. The air bag 300, only a portion of which is illustrated in FIGS. 14-17, is constructed in a manner similar to the air bags discussed with reference to FIGS. 1-11. The air bag 300 includes an outer panel (not shown) and side panels 302. The outer panel and the side panels 302 may be different portions of a single piece of material or may be separate pieces of material that are sewn together to form the air bag 300. The outer panel and the side panels 302 of the air bag 300 collectively define an inflatable volume 304 of the air bag.

Ends 306 of the side panels 302 of the air bag 300 opposite the outer panel define a mouth portion 308 of the air bag. The mouth portion 308 of the air bag 300 defines an inflation fluid opening for receiving inflation fluid into the inflatable volume 304 of the air bag. The side portions 302 of the air bag 300, at locations adjacent the ends 306, include multiple flow openings through which inflation fluid may flow out of the inflatable volume 304 of the air bag. FIG. 14 illustrates one of the flow openings at 310. The side panels 302 of the air bag 300 also include through-holes for receiving fasteners. FIG. 15 illustrates one of the through-holes at 312.

The air bag module 10d also includes an inflator 320 that is actuatable for providing inflation fluid for inflating the air bag 300. As shown in FIG. 14, the inflator 320 includes a circular base portion 322 and a cylindrical housing portion 324. Flow passages 326 extend through the housing portion 324 of the inflator 320. Upon actuation of the inflator 320, inflation fluid exits the inflator 320 through the flow passages 326. An annular protrusion 328 is located on a side of the base portion 322 opposite the housing portion 324. Vehicle electronics (not shown) may be connected to the inflator 320 through a port (not shown) in the annular protrusion 328.

A support member 336 of the air bag module 10d supports the inflator 320 and receives the reaction forces resulting from actuation of the inflator. In the illustrated embodiment, the support member 336 is a reaction plate. The reaction plate 336 is formed from single piece of material, such as metal or high strength plastic. As shown in FIGS. 12, and 13, the reaction plate 336 has a generally square end wall 338. The end wall 338 includes an exterior surface 340 (FIG. 12) and an opposite interior surface 342 (FIG. 13).

A circular inflator opening 346 (FIG. 14) extends through the end wall 338 of the reaction plate 336. A flange 348 that extends perpendicularly to the end wall 338 and parallel to axis 350 (FIG. 14) defines the inflator opening 346. The inflator opening 346 is centered on axis 350 and has a diameter that is sized for receiving the housing portion 324 of the inflator 320. As shown in FIG. 14, when the inflator 320 is received in the inflator opening 346 of the end wall 338 of the reaction plate 336, the base portion 322 of the inflator 320 abuts the flange 348. The base portion 322 of the inflator 320 is fixed relative to the flange 348 of the reaction plate 336 in a known manner, such as by welding.

Dashed lines in FIG. 12 illustrate four vent openings 360, 362, 364, and 366 that extend through the end wall 338 of the reaction plate 336. The four vent openings 360, 362, 364, and 366 form an array about the inflator opening 346 and are equally spaced from one another. As shown in FIG. 12, the four vent openings include an upper vent opening 360, a lower vent opening 362, a right vent opening 364, and a left vent opening 366. The upper and lower vent openings 360 and 362 are located on diametrically opposite sides of the inflator opening 346. Likewise, the right and left vent openings 364 and 366 are located on diametrically opposite sides of the inflator opening 346.

The end wall 338 of the reaction plate 336 also includes four fastener holes 372 (FIG. 12) and four through-holes. One of the through-holes is shown in FIGS. 14 and 15 at 374. In the reaction plate illustrated in FIG. 12, one fastener hole 372 is located intermediate each set of adjacent vent openings 360, 362, 364, and 366. The through-holes 374 in the end wall 338 are located on laterally opposite sides of the upper and lower vent openings 360 and 362.

As shown in FIG. 13, the reaction plate 336 also includes opposite first and second side wall portions 380 and 382, respectively. The first and second side wall portions 380 and 382 extend away from and generally perpendicular to the interior surface 342 of the end wall 338 from laterally opposite edges of the end wall. The first and second side wall portions 380 and 382 help to support a cover (not shown) of the air bag module 10d and also provide additional mounting surfaces for mounting the reaction plate 336 to a vehicle.

A bag retainer 390 secures the air bag 300 relative to the reaction plate 336. FIG. 13 illustrates a plan view of the bag retainer 390 attached to the interior surface 342 of the end wall 338 of the reaction plate 336. The bag retainer 390 includes an annular central portion 392 that comprises an annular wall extending generally perpendicular to the remainder of the bag retainer 390. As shown in FIG. 14, an inner diameter of the central portion 392 of the bag retainer 390 is larger than the diameter of the housing portion 324 of the inflator 320. The bag retainer 390 also includes four lobed portions 400. The four lobed portions 400 extend away from the central portion 392 generally perpendicular to axis 350, as is shown in FIG. 13. The four lobed portions 400 are equally spaced about the circumference of the central portion 392 and collectively define a generally square outer profile of the bag retainer 390.

With reference to FIG. 13, each of the four lobed portions 400 includes an arcuate outer surface 402 that defines a rounded corner of the generally square outer profile of the bag retainer 390. The arcuate outer surface 402 of each lobed portion 400 extends between first and second side surfaces 404 and 406, respectively. The first and second side surfaces 404 and 406 of each lobed portion 400 extend perpendicular to one another. As shown in FIG. 15 with reference to one of the four lobed portions 400, each lobed portion also includes upper and lower surfaces 408 and 410, respectively.

The bag retainer 390 defines four openings 416. Each opening 416 is located between the second side surface 406 of one lobed portion 400 and the first side surface 404 of an adjacent lobed portion. The outer circumference of the central portion 392 of the bag retainer 390 extends along a radially inner portion of each opening 416. The four openings 416 of the bag retainer 390 align with the four vent openings 360, 362, 364, and 366 in the end wall 338 of the reaction plate 336 when the bag retainer is secured to the reaction plate, as is shown in FIG. 13.

Four fasteners 420 (FIG. 13) secure the bag retainer 390 to the end wall 338 of the reaction plate 336. Each fastener 420 extends through a different one of the four lobed portions 400 of the bag retainer 390 in a direction parallel to axis 350. FIG. 13 illustrates head portions 422 of the four fasteners 420. Each one of the four fasteners 420 is associated with a fastener hole 372 in the end wall 338 of the reaction plate 336. Each fastener 420 extends through its associated fastener hole 372. A nut 424 (FIG. 12) is received on each fastener 420 for securing the bag retainer 390 relative to the end wall 338 of the reaction plate 336.

The bag retainer 390 also includes four through-holes. FIG. 15 shows one of the through-holes at 430. A through-hole 430 extends through each one of the four lobed portions 400 of the bag retainer 390. Each through-hole 430 of the bag retainer 390 has an associated through-hole 374 in the end wall 338 of the reaction plate 336.

The air bag module 10d also includes a vent member 440. The vent member 440 is preferably formed from a single piece of material and not from multiple pieces secured together. The vent member 440 shown in FIG. 12 is planar and is generally cross-shaped. The vent member includes opposite upper and lower surfaces 442 and 444, respectively (FIG. 15). As shown in FIG. 12, a circular opening 448 extends through the center of the vent member 440. The circular opening 448 has a diameter that is larger than the diameter of the flange 348 of the end wall 338 of the reaction plate 336 so that the vent member 440 may extend circumferentially around the flange and thus, circumferentially around the inflator 320, as is shown in FIGS. 12 and 14.

As shown in FIG. 12, the vent member 440 includes four rectangular protrusions 450, 452, 454, and 456. The four rectangular protrusions 450, 452, 454, and 456 of the vent member 440 are equally spaced from one another and extend radially outwardly relative to the circular opening 448. The four rectangular protrusions include an upper protrusion 450, a lower protrusion 452, a right protrusion 454, and a left protrusion 456. The upper protrusion 450 is associated with the upper vent opening 360 and is sized for covering the upper vent opening. The lower protrusion 452 is associated with the lower vent opening 362 and is sized for covering the lower vent opening. The right protrusion 454 is associated with the right vent opening 364 and is sized for covering the right vent opening. The left protrusion 456 is associated with the left vent opening 366 and is sized for covering the left vent opening.

Two through-holes 460 extend through the upper protrusion 450 of the vent member 440. The two through-holes 460 are located adjacent laterally opposite edges of the upper protrusion 450. Each of the two through-holes 460 aligns with an associated through-hole 374 in the end wall 338 of the reaction plate 336, as is shown with reference to one through-hole 460 in FIG. 15. Similarly, two through-holes 462 extend through the lower protrusion 452 of the vent member 440. The two through-holes 462 are located adjacent laterally opposite edges of the lower protrusion 452. Each of the two through-holes 462 aligns with an associated through-hole 374 in the end wall 338 of the reaction plate 336.

The air bag module 10d includes four fasteners 470 for attaching the vent member 440 to the reaction plate 336. The four fasteners 470 are of the type commonly referred to as “Christmas tree pins.” FIG. 15 illustrates an enlarged sectional view of one of the four pins 470.

Each pin 470 includes a head portion 472 and a shank portion 474. In the embodiment illustrated, the head portion 472 of the pin 470 includes a rounded lower surface 476 and a flat upper surface 478. The shank portion 474 of the pin 470 extends away from the flat upper surface 478 of the head portion 472 and includes a generally cylindrical main body portion 480. Multiple tabs 482 extend outwardly of the main body portion 480 of the shank portion 474 of the pin 470. The tabs 482 extend circumferentially around the main body portion 480 of the shank portion 474 of the pin 470 and are axially spaced from one another along the shank portion.

As viewed with respect to one tab 482 in FIG. 15, each of the tabs 482 includes an angled or tapered upper surface 484 and a generally opposed, flat lower surface 486. Each tab 482 is adapted to flex inwardly toward the main body portion 480 when a force acts upon the tapered upper surface 484 of the tab. A portion of the tabs 482 illustrated in FIGS. 14 and 15 are flexed inwardly. When the force is removed, the tabs 482 resiliently return to their original positions. When a force is applied to the flat lower surface 486 of each tab 482, the tab 482 resists inward movement. Thus, the tabs 482 of the shank portion 474 of the pin 470 enable movement along the shank portion in a direction toward the head portion 472 of the pin and prevent movement of along the shank portion in a direction away from the head portion of the pin.

The vent member 440 is attached to the reaction plate 336 on a side of the reaction plate opposite the air bag 300. As shown in FIG. 15, with reference to one of the four pins 470, the shank portion 474 of the pin 470 is inserted through aligned through-holes 460, 374, 312, and 430 in the vent member 440, the end wall 338, the air bag 300, and the bag retainer 390, respectively. The head portion 472 of the pin 470 is spaced away from the vent member 440 and the shank portion 474 of the pin holds the vent member against the exterior surface 340 of the end wall 338. The flat lower surface 486 of a tab, indicated in FIG. 15 at 490, engages the upper surface 408 of a lobed portion 400 of the bag retainer 390 for securing the pin 470 relative to the bag retainer and relative to the end wall 338 of the reaction plate 336.

The air bag module 10d also includes tethers 494. Preferably, the air bag module 10d includes four tethers 494. FIGS. 14, 16, and 17 illustrate a portion of one of the tethers 494. As shown in FIG. 14, the tether 494 extends through the flow opening 310 in the air bag 300 and through a vent opening 364 in the end wall 338 of the reaction plate 336 and is attached to the right protrusion 454 of the vent member 440. As with the embodiments described above with reference to FIGS. 1-11, another portion of the tether 494 is attached to the outer panel of the air bag 300. The other tethers (not shown) of the air bag module 10d also extend through associated vent openings to attach to the vent member 440.

The air bag module 10d of FIGS. 12-17 operates in a manner similar to the air bag module 10c of FIG. 7. When the vent member 440 is positioned relative to the end wall 338 of the reaction plate 336 so that the protrusions 450, 452, 454, and 456 of the vent member close the vent openings 360, 362, 364, and 366, respectively, the vent member 440 is said to be in a first condition. FIG. 14 illustrates the vent member 440 in the first condition. When the vent member 440 is in the first condition, debris and other foreign matter are prevented from entering the air bag module 10d through the vent openings 360, 362, 364, and 366. The vent member 440 of the air bag module 10d is in the first condition prior to actuation of the inflator 320. The tabs 482 of the pins 470 that are located in the through-holes 460 of the vent member 440 act on the vent member to secure the vent member in the first condition. Thus, with reference to FIG. 15, the resiliency of the tabs 482 that are flexed inwardly applies a force to the vent member 440 to secure the vent member in the first condition.

Also prior to actuation of the inflator 320, there is a significant amount of slack in the tethers 494. The slack is present because the length of each tether 494 is greater than the distance between vent member 440 and the portion of the air bag 300 at which the tether is attached to the outer panel.

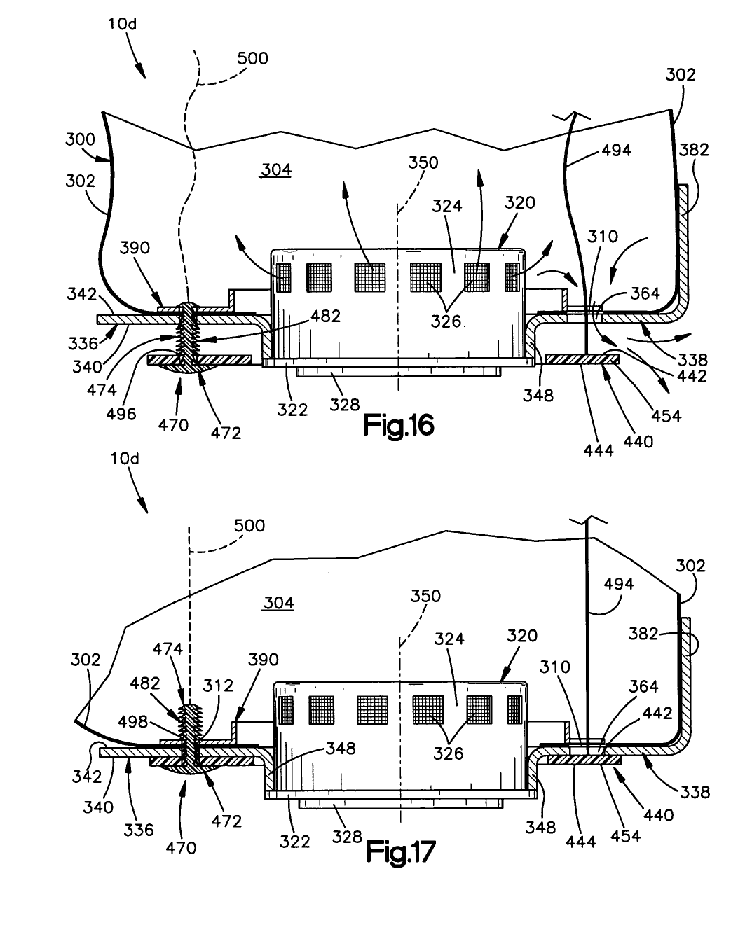

The vent member 440 also has a second condition. FIG. 16 illustrates the vent member 440 in the second condition. In the second condition, the vent member 440 is spaced away from the end wall 338 of the reaction plate 336, and the vent openings 360, 362, 364, and 366 are open so that inflation fluid may flow out of the air bag module 10d through the vent openings, as is shown with respect to the vent opening 364 in FIG. 16. FIG. 16 illustrates the vent member 440 being uniformly spaced away from the end wall 338 of the reaction plate 336 when the vent member is in the second condition. The vent member 440 moves from the first condition to the second condition in response to initial inflation of the air bag 300. When the inflator 320 of the air bag module 10d is actuated, inflation fluid exits the inflator 320 and begins to fill the inflatable volume 304 of the air bag 300. As inflation fluid enters the air bag 300, the inflation fluid pressure within the air bag 300 increases. The inflation fluid pressure within the air bag 300 acts through the vent openings 360, 362, 364, and 366 on the upper surface 442 of the vent member 440. Since the lower surface 444 of the vent member 440 is subject to atmospheric pressure, a pressure differential arises across the vent member 440. When the pressure differential reaches a predetermined level, the vent member 440 moves downwardly, as viewed in FIG. 14, from the first condition to the second condition.

The predetermined level of the pressure differential is a level sufficient to overcome the force applied to the vent member 440 by the tabs 482 that extend through the through-holes 460 of the vent member and secure the vent member in the first condition. The force applied to the vent member 440 by the tabs 482 may be controlled or tuned by changing the dimensions of the through-hole 460, the dimensions of the main body portion 480 and the tabs 482 of the pin 470, the material properties, such as the flexibility, of the pin, or by any combination of the above-mentioned variables.

The vent member 440 moves downwardly, as viewed in FIG. 14, until the lower surface 444 of the vent member 440 engage the flat upper surfaces 478 of the head portions 472 of the pins 470. The head portions 472 of the pins 470 prevent further downward movement of the vent member 440 and ensure that the vent member is stopped in the second condition, shown in FIG. 16.

At the point of air bag deployment illustrated in FIG. 16, the output of inflation fluid from the inflator 320 is greater than the amount of inflation fluid that may exit the air bag module 10d through the vent openings 360, 362, 364, and 366. As a result, the inflation fluid pressure within the air bag 300 continues to increase after the vent member 440 has moved to the second condition. The increasing inflation fluid pressure in the air bag 300 results in deployment of the air bag from the air bag module 10d.

As the air bag 300 inflates, the outer panel of the air bag 300 moves away from the reaction plate 336 and away from the vent member 440. If the outer panel moves away from the reaction plate 336 by less than a predetermined amount, slack remains in the tethers 494. The outer panel of the air bag 300 may move away from the reaction plate 336 by less than the predetermined amount, for example, if the air bag 300 when inflating engages a vehicle occupant who is positioned relatively close to the reaction plate 336. The engagement of the air bag 300 with the relatively close vehicle occupant stops or limits the movement of the outer panel of the air bag away from the reaction plate 336 and away from the vent member 440.

When slack remains in the tethers 494 as a result of the outer panel moving away from the reaction plate 336 by less than the predetermined amount, the tethers 494 do not pull on the vent member 440. The vent member 440 remains in the second condition spaced apart from the reaction plate 336 and apart from the vent openings 360, 362, 364, and 366. The vent openings 360, 362, 364, and 366 remain open, enabling the flow of inflation fluid away from the air bag 300 and to atmosphere through the vent openings. This venting of the air bag 300 can reduce the force and pressure with which the air bag inflates.

When the outer panel of the air bag 300 moves away from the reaction plate 336 beyond the predetermined amount, the slack is completely removed from the tethers 494 and the tethers are tensioned. The tensioned tethers 494 pull the vent member 440 from the second condition, shown in FIG. 16, back toward the first condition in which the vent member 440 blocks the flow of inflation fluid through the vent openings 360, 362, 364, and 366. The vent member 440 acts to restrict the flow of inflation fluid through the vent openings 360, 362, 364, and 366 during movement from the second condition back toward the first condition. When the vent member 440 has moved back into the first condition during inflation of the air bag 300, as shown in FIG. 17, the air bag 300 inflates with full force and pressure.

As set forth above, prior to actuation of the inflator 320, the head portion 472 of the pin 470 is spaced apart from the vent member 440 and the shank portion 474 of the pin secures the vent member against the exterior surface 340 of the end wall 338. When inflation fluid pressure acts on the vent member 440 to move the vent member from the first condition to the second condition, the flat lower surface 486 of the tab 490 (FIG. 15) that is engaging the upper surface 408 of the lobed portion 400 of the bag retainer 390 prevents movement of the pin 470 downward, as viewed in FIG. 15, relative to the reaction plate 336. Since the tabs 482 of the shank portion 474 of the pin 470 enable movement along the shank portion in a direction toward the head portion 472, i.e., downward, as viewed in FIG. 15, the vent member 440 moves along the shank portion of the pin when moving from the first condition to the second condition.

When the vent member 440 is in the second condition, illustrated in FIG. 16, the lower surface 486 of tab 496 engages the upper surface 442 of the vent member 440 to lock the pin 470 for movement with the vent member. If, during inflation of the air bag 300, the outer panel of the air bag 300 moves away from the reaction plate 336 beyond the predetermined amount, the tensioned tethers 494 pull the vent member 440 from the second condition back toward the first condition, i.e., upward, as viewed in FIG. 16. Since tab 496 fixes the pin 470 for movement with the vent member 440, the upward movement of the vent member 440 back toward the first condition moves the pin 470 upwardly, as viewed in FIG. 16. Since the tabs 482 of the shank portion 474 of the pin 470 allow for movement along the shank portion toward the head portion 472, the shank portion 474 of the pin 470 moves upwardly through the through-holes 430, 312, and 374 in the end wall 338 of the reaction plate 336, the air bag 300, and the bag retainer 390, respectively, as the pin 470 moves upwardly with the vent member 440.

During the upward movement, the lower surface of each tab 486 exiting the through-hole 430 of the bag retainer 390 prevents movement of the pin 470 and the vent member 440 downwardly, as viewed in FIGS. 15 and 16, and back toward the second condition. Thus, each tab 482 acts to block movement of the vent member 440 back toward the second condition. If the tethers 494, in response to inflation of the air bag 300, return the vent member 440 to the first condition, as shown in FIG. 17, the lower surface 486 of tab 498 engages the upper surface 408 of the bag retainer 390 and blocks any subsequent movement of the vent member 440 away from the first condition.

Dashed lines labeled 500 in FIGS. 14-17 illustrate an alternative arrangement for the tethers 494 of the air bag module 10d. Instead of the tethers 494 passing through the vent openings 360, 362, 364, and 366 and being attached to the vent member 440, the tethers 494 may be fixed to the end of the shank portion 474 of the pin 470 opposite the head portion 472. When a tether 494 is tensioned as a result of the outer panel of the air bag 300 moving away from the reaction plate 336 beyond the predetermined amount, the tethers 494 act to pull the pins 470 upward, as viewed in FIG. 16, relative to the end wall 338 of the reaction plate 336. During upward movement of the pins 470, the head portions 472 of the pins 470 act on the vent member 440 to move the vent member back toward the first condition.

From the above description of the invention, those skilled in the art will perceive improvements, changes, and modifications in the invention. Such improvements, changes, and modifications within the skill of the art are intended to be covered by the appended claims.

1. A vehicle occupant protection apparatus comprising:
an inflatable vehicle occupant protection device;
a support member having a vent opening;
a vent member associated with the vent opening and having a first condition in which the vent member closes the vent opening and a second condition in which the vent member is spaced apart from the vent opening enabling fluid flow through the vent opening; and
a fastener for attaching the vent member to the support member, the fastener including structure for securing the vent member in the first condition prior to initial inflation of the protection device and for enabling the vent member to move from the first condition to the second condition upon initial inflation of the protection device.

2. The vehicle occupant protection device of claim 1 wherein the structure of the fastener acts on the vent member for resisting movement of the vent member from the first condition to the second condition until a predetermined pressure differential across the vent member is reached.

3. The vehicle occupant protection device of claim 1 wherein the structure of the fastener includes a plurality of tabs that are formed on a shank portion of the fastener, the plurality of tabs enabling relative movement between the vent member and the shank portion in a first direction and resisting relative movement between the vent member and the shank portion in a second, opposite direction.

4. The vehicle occupant protection device of claim 3 wherein each tab of the plurality of tabs has generally opposed first and second surfaces, the tab being configured for flexing toward the shank portion of the fastener when a force acts on the first surface and being configured for resisting a force acting on the second surface.

5. The vehicle occupant protection device of claim 3 wherein the fastener also includes a head portion, the first direction of movement being movement along the shank portion toward the head portion, the vent member engaging the head portion of the fastener when the vent member reaches the second condition.

6. The vehicle occupant protection device of claim 1 further including a tether associated with the vent member and responsive to inflation of the protection device away from the support member beyond a predetermined amount for moving the vent member from the second condition back toward the first condition for restricting fluid flow through the vent opening.

7. The vehicle occupant protection device of claim 6 wherein the tether extends between the protection device and one of the vent member and the fastener, the tether being tensioned when the protection device inflates away from the support member beyond the predetermined amount.

8. The vehicle occupant protection device of claim 1 wherein the fastener is a first fastener, the vehicle occupant protection apparatus further including a second fastener that also includes structure for securing the vent member in the first condition prior to initial inflation of the protection device and for enabling the vent member to move from the first condition to the second condition upon initial inflation of the protection device, the second fastener being spaced away from the first fastener.

9. The vehicle occupant protection device of claim 8 wherein the support member includes an end wall through which the vent opening extends, the vent member being planar and, when in the second condition, being uniformly spaced away from the end wall.

10. The vehicle occupant protection device of claim 1 wherein the support member supports an inflator that is actuatable for providing inflation fluid, the vent opening being a first vent opening, a second vent opening extending through the support member on a side of the inflator opposite the first vent opening, the vent member, when in the first condition, closing both the first and second vent openings and, when in the second condition, being spaced apart from the support member for enabling fluid flow through both the first and second vent openings.

11. The vehicle occupant protection device of claim 10 wherein the vent member extends circumferentially around the inflator.

12. The vehicle occupant protection device of claim 10 further including a tether that is associated with the vent member and that, in response to inflation of the protection device relative to the support member beyond a predetermined amount, moves the vent member toward the support member for restricting fluid flow through the first and second vent openings.

13. The vehicle occupant protection device of claim 1 wherein the support member supports an inflator that is actuatable for providing inflation fluid, the vent opening being one of a plurality of vent openings that extend through the support member, the vent openings being formed in an array about the inflator, the vent member being associated with the plurality of vent openings and extending circumferentially around the inflator, the vent member, when in the first condition, closing the plurality of vent openings and, when in the second condition, being spaced away from the support member for enabling fluid flow through the plurality of vent openings.

14. The vehicle occupant protection device of claim 13 further including a tether associated with the vent member and being responsive to inflation of the protection device away from the support member by more than a predetermined amount for moving the vent member toward the support member for restricting fluid flow through the plurality of vent openings.

15. A vehicle occupant protection apparatus comprising:
an inflatable vehicle occupant protection device;
an inflator that is actuatable for providing inflation fluid for inflating the protection device;
a support member supporting the inflator, first and second vent openings extending through the support member on opposite sides of the inflator;
a vent member having a first portion associated with the first vent opening and a second portion associated with the second vent opening, the vent member being spaced away from the support member for enabling fluid flow through the first and second vent openings and moving toward the support member for restricting fluid flow through the first and second vent openings; and
a tether associated with the vent member and, in response to inflation of the protection device relative to the support member beyond a predetermined amount, moving the vent member toward the support member for restricting fluid flow through the first and second vent openings.

16. The vehicle occupant protection device of claim 15 wherein the vent member extends circumferentially around the inflator.

17. The vehicle occupant protection device of claim 15 wherein the vent member has a first condition in which the vent member closes the first and second vent openings and a second condition in which the vent member is spaced apart from the first and second vent openings enabling fluid flow through the first and second vent openings, the tether, in response to inflation of the protection device relative to the support member beyond the predetermined amount, moving the vent member from the second condition toward the first condition.

18. The vehicle occupant protection device of claim 17 further including a fastener for attaching the vent member to the support member, the fastener including structure for securing the vent member in the first condition prior to initial inflation of the protection device and for enabling the vent member to move from the first condition to the second condition upon initial inflation of the protection device.

19. The vehicle occupant protection device of claim 18 wherein the structure of the fastener acts on the vent member for resisting movement of the vent member from the first condition to the second condition until a predetermined pressure differential across the vent member is reached.

20. The vehicle occupant protection device of claim 18 wherein the tether extends between the protection device and one of the vent member and the fastener, the tether being tensioned when the protection device inflates away from the support member beyond the predetermined amount.

21. The vehicle occupant protection device of claim 18 wherein the structure of the fastener includes a plurality of tabs that are formed on a shank portion of the fastener, the plurality of tabs enabling relative movement between the vent member and the shank portion in a first direction and resisting relative movement between the vent member and the shank portion in a second, opposite direction.

22. The vehicle occupant protection device of claim 21 wherein each tab of the plurality of tabs has generally opposed first and second surfaces, the tab being configured for flexing toward the shank portion of the fastener when a force acts on the first surface and being configured for resisting a force acting on the second surface.

23. The vehicle occupant protection device of claim 21 wherein the fastener also includes a head portion, the first direction of movement being movement along the shank portion toward the head portion, the vent member engaging the head portion of the fastener when the vent member reaches the second condition.

24. The vehicle occupant protection device of claim 18 wherein the fastener is a first fastener, the vehicle occupant protection apparatus further including a second fastener that also includes structure for securing the vent member in the first condition prior to initial inflation of the protection device and for enabling the vent member to move from the first condition to the second condition upon initial inflation of the protection device, the second fastener being spaced away from the first fastener.

25. The vehicle occupant protection device of claim 24 wherein the support member includes an end wall through which the first and second vent openings extend, the vent member being planar and, when in the second condition, being uniformly spaced away from the end wall.

26. A vehicle occupant protection apparatus comprising:
an inflatable vehicle occupant protection device;
an inflator that is actuatable for providing inflation fluid for inflating the protection device;
a support member for supporting the inflator, a plurality of vent openings extending through the support member, the vent openings being formed in an array about the inflator;
a vent member associated with the plurality of vent openings and extending circumferentially around the inflator, the vent member being spaced away from the support member for enabling fluid flow through the plurality of vent openings and moving toward the support member for restricting fluid flow through the plurality of vent openings; and
a tether associated with the vent member and responsive to inflation of the protection device away from the support member by more than a predetermined amount for moving the vent member toward the support member for restricting fluid flow through the plurality of vent openings.

27. The vehicle occupant protection device of claim 26 wherein the vent member has a first condition in which the vent member closes the plurality of vent openings and a second condition in which the annular vent member is spaced apart from the plurality of vent openings enabling fluid flow through the plurality of vent openings, the tether, in response to inflation of the protection device relative to the support member beyond the predetermined amount, moving the vent member from the second condition toward the first condition.

28. The vehicle occupant protection device of claim 27 further including a fastener for attaching the vent member to the support member, the fastener including structure for securing the vent member in the first condition prior to initial inflation of the protection device and for enabling the vent member to move from the first condition to the second condition upon initial inflation of the protection device.

29. The vehicle occupant protection device of claim 28 wherein the structure of the fastener includes a plurality of tabs that are formed on a shank portion of the fastener, the plurality of tabs enabling relative movement between the vent member and the shank portion in a first direction and resisting relative movement between the vent member and the shank portion in a second, opposite direction.

30. The vehicle occupant protection device of claim 28 wherein the fastener is a first fastener, the vehicle occupant protection apparatus further including a second fastener that also includes structure for securing the vent member in the first condition prior to initial inflation of the protection device and for enabling the vent member to move from the first condition to the second condition upon initial inflation of the protection device, the second fastener being spaced away from the first fastener.

31. The vehicle occupant protection device of claim 30 wherein the support member includes an end wall through which the plurality of vent openings extend, the vent member being planar and, when in the second condition, being uniformly spaced away from the end wall.
